(19) United States
(12) Patent Application Publication
(10) Pub. No.: US 2006/0174922 A1
(43) Pub. Date: Aug. 10, 2006

(54) Device and method for disinfecting a milking component

(76) Inventors: Thomas Mader, Rheda-Wiedenbruck (DE); Uwe Osthues, Menden (DE); Udo Frische, Oelde (DE)

Correspondence Address: Jeffry W Smith;Smith Law Office, 440 Science Drive, Suite 302, Madison, WI, 53711, US

(21) Appl. No.: 10/531,356

(22) PCT Filed: Oct. 17, 2003
(86) PCT No.: PCT/EP03/11563

§ 371 Date: Mar. 1, 2006

(30) Foreign Application Priority Data
Oct. 17, 2002 (DE) 102 48 561.5

(51) Int. Cl. B08B 7/00

(52) U.S. Cl. 134/42

(57) ABSTRACT

The invention relates to a device and a method for disinfecting a milking component, said device comprising a container for storing a disinfectant base material, and a processing unit. Said processing unit can be used to produce a disinfectant containing chlorine dioxide, from the disinfectant base material by means of a chemical reaction. A guiding element is used to bring the disinfectant into contact with the milking component, essentially directly after being produced, in order to disinfect the milking component.

The present invention is concerned with the field of milking of animals, especially of cows. Specifically the present invention is concerned with a device for the disinfection of milking components or of components in milking technology and with a method for disinfecting components in milking technology, for example, for the disinfection of a teat cup, a teat cleaning equipment, milk line, or a milking installation.

Although the invention will be described below with reference to the use of milking installations for the milking of cows, it should be pointed out that the invention can also be used for the milking of other animals, which provide milk. Especially, the invention is suitable for use in milking installations for cows, sheep, goats, horses, asses, camels, llamas and dromedaries, elk, reindeer and buffalo and other mammals.

Disinfection is defined here as the disinfection of the entire milking installation or individual components in milking technology, with the purpose of reducing the germ and pathogen concentration. This also includes especially the disinfection of individual or all other milking-technological components in order to kill germs, bacteria or similar or to reduce their number.

In the case of highly contaminated components, it may occur that a sufficient cleaning effect is not achieved by using just a disinfectant. The reason for this could be that the dirt adheres to one or several surfaces and cannot be removed by disinfection alone. Then, before or together with disinfection, cleaning as well makes sense and is optionally necessary. This can be done, for example, mechanically or chemically.

For example, an additional cleaning makes sense when, for example, large pieces of excrement adhere to an udder-cleaning brush, since then by disinfection alone under certain circumstances freedom from germs cannot be achieved. In such a case cleaning of the udder-cleaning brush makes sense. In addition or at the same time by disinfection, the germ load on the udder-cleaning brush can be reduced significantly. The disinfection itself can take place using an appropriate concentration of disinfectant and with other parameters proper for practical application (time, temperature, etc.). For these reasons, in the sense of this invention, cleaning and disinfection will be distinguished, although both steps may occur in a combined step.

Namely, in the state of the art, frequently a combined cleaning and disinfection method is used in which, for example, the milk-conducting parts of a milking installation are cleaned and disinfected. The disinfection can occur at the same time with the cleaning process. The cleaning action is performed, for example, by a batch method, in which individual plugs of fluid are sent through the installation in a batch method. This also applies to a mechanical cleaning action. By simultaneous or successive use of cleaners (for example, in the form of solvents) and of disinfectants, cleaning and disinfection of the milking installation can be accomplished. The disinfectant action can also take place at high temperatures (cleaning with boiling water).

So far mostly products based on peracetic acid have been used as chemical disinfectants for milking installations. Such a method is described, for example, in DE 195 41 646 A1. Another cleaning method is disclosed in WO 00/067561 A1. Another possibility is disinfection with UV radiation, but this is complex and expensive. Therefore, in the state of the art frequently disinfectants based on peracetic acid are used. The disadvantage of this is that some of the operating personnel exhibit compatibility problems upon frequent (skin) contact.

Therefore, the task of the invention is to make available a device and a method for the cleaning of milk-technological components, which provides better properties.

The device according to the invention is the object of Claim 1 and the method according to the invention is the object of Claim 25. Preferred further developments are the objects of the subclaims.

According to the invention, the device for the disinfection of a milk-technological component has at least one container for storing at least one disinfectant base material. At least one processing device is provided with which at least one disinfectant material can be prepared from disinfectant base material by chemical reaction, the disinfectant preferably containing chlorine dioxide. Furthermore, a guiding element is provided with which, essentially directly after preparation, the disinfectant can be brought into contact with at least one milk-technological component, in order to disinfect the milk-technological component.

A device according to the invention for the milking of an animal includes at least one milking device, at least one milk line, at least one vacuum line, at least one container for a disinfectant base material and at least one processing device. The processing device is provided in order to produce a disinfectant from at least one disinfectant base material by chemical reaction, the disinfectant preferably containing chlorine dioxide. The disinfectant is suitable for disinfecting the device. Preferably, the device according to the invention has at least one milk cup or teat cup.

The method according to the invention includes the step of preparation of the disinfectant from at least one disinfectant base material, whereby the disinfectant preferably contains chlorine dioxide. Then at least one milking component, that is, a component in milk technology, is disinfected with the prepared disinfectant.

The device according to the invention and the method according to the invention have many advantages.

The use of chlorine dioxide in aqueous solution for disinfection has many advantages. Chlorine dioxide (ClO₂) has been used successfully for swimming pool disinfection. However, since the finished solvent is unstable, it cannot be transported but it must be prepared on location. In comparison to chlorine, chlorine dioxide has the advantage of a significantly higher oxidizing power (about 2.5 times). In addition, chlorine dioxide does not have some of the disadvantages related to the use of chlorine, for example, the problem of haloforms.

Another advantage when using chlorine dioxide is that the odor is reduced in comparison to using peracetic acid. In addition, the biofilm is removed reliably.

Since chlorine dioxide is not an organic substance, the potential for allergies has been reduced considerably. This is a considerable advantage in comparison to the usually-employed peracetic acid.

Similarly, chlorine dioxide does not form any toxic substances, such as trihalomethanes, chlorophenols and chloramines.

A quite significant advantage of using chlorine dioxide is that it is approved for the preparation and for the disinfection of drinking water.

In addition, it is suitable for the destruction of spores, viruses, bacteria and other pathogens, as well as of phenols and THM precursors. It increases the coagulability and removes iron and magnesium compounds more reliably. Since chlorine dioxide is prepared by chemical reaction from basic components, only small amounts of basic components have to be transported, which reduces transportation and storage costs. Although the installation requires high technological and financial expenditure, it is possible to reduce the operating costs. This is an important advantage. Furthermore, the time of the reaction can be reduced.

The conventionally employed peracetic acid requires safe handling and results in higher operating costs, because it is a hazardous substance during transportation. Since chlorine dioxide is produced locally, the transportation costs are significantly lower since, as a rule, only the disinfectant base material needs to be transported. In addition, peracetic acid is an organic substance and thus has an allergy potential for humans and animals. Furthermore, biofilm, fats, mucus and deposits are not degraded, in contrast to chlorine dioxide.

When chlorine is used as disinfectant as such, in case of improper handling there is a danger of caustic reaction, and there are other dangers, such as gas evolution or a caustic reaction on the skin and eyes. Thus, there are significant advantages of chlorine dioxide in this respect too.

Disinfection with chlorine dioxide also has advantages in comparison to disinfection with boiling water, since in that case significant amounts of energy have to be used for heating. Since this is done mostly electrically and the performance of available electrical connections is relatively low in remote farms, a great deal of time is required for the heating. On the other hand, chlorine dioxide is available for disinfection without almost any time delay. The planning of the daily schedule can thus become more flexible.

In order to control the progress of preparation, preferably a control device is provided which combines the corresponding parts of water and disinfectant base material so that the disinfectant base material can react and produce the disinfectant.

The chlorine dioxide solution can be prepared, for example, as described in German Patent Application DE 195 18 464 A1. However, there are other devices and methods known in the state of the art for the preparation of a chlorine dioxide solution.

The term “essentially directly after preparation” is understood in the sense of this application to mean a production of the disinfectant which is oriented to need. It does not have to be consumed immediately, but an intermediate container or intermediate storage can be provided for finished or enriched disinfectant. The size of the storage can be variable. The size of the container can be adapted to the need for disinfectant over a period of one hour or also for a period of one day or even for a longer period.

In a preferred further development, the milking component touches the animal or is a component which touches the udder or the teat or a part thereof and thus comes into contact with it. It is also possible that the milking component will come into contact with the milked milk.

Preferably, the milking component to be disinfected is chosen from a group of components which includes teat rubber, teat cup, udder- and teat-cleaning equipment and teat-cleaning cloths, pre- and post-dipping devices or similar others. Dipping cups, premilking cups and any robot arms present can be disinfected.

The disinfection of teat rubber and teat cups is important especially in the case of sick animals, since the teat of the next animal comes into contact with this component and thus there is a great danger of contagion. When using chlorine dioxide there is the advantage of the significantly lower allergy potential.

According to the invention, a disinfectant with chlorine dioxide can be used for the disinfection of the teat-cleaning equipment. The use of a disinfectant with chlorine dioxide is also preferred when cleaning the teats with the teat-cleaning equipment.

Preferably a disinfectant container is provided in which at least one milking component can be immersed in order to make disinfection essentially on all sides possible. Thus, for example, a teat cup can be subjected to disinfection by rinsing the entire head. Similarly, equipment for milk quality determination can be disinfected.

The disinfectant can also be used for the preparation of the water used. Disinfection can be performed, for example, after a certain number of animals or after the milking of the herd or at predetermined intervals.

The milking component to be disinfected can be a component with which the milk of a milked animal comes into contact. Preferably the milking component includes a group of components which comprise teat rubber, teat cup, milk collecting parts, milk lines, collecting parts, milk tubings and also long milk tubings, milk flow meters, sensors for the determination of the milk quality and flock and blood detectors, conductivity and temperature sensors, milk lines, the end unit of the milk pump, the receiving container, the safety separator, the pressure line and the milk tank, also including plate cooler and valve technology, receiving containers and milk pumps and similar others. Disinfection of any individual or all of these components is preferred.

The disinfectant can be circulated in a closed circuit and can be adjusted preferably during the next cycle in order to adjust the concentration again.

The milking component to be disinfected can also be a component with which an animal comes into contact, whereby these components belong to the group of components that includes animal watering troughs as well as water lines to the animal water troughs, feed troughs and calf drinking troughs and calf nipples, areas where the animals are lying, milking stations, the floor of the milking station, the area of lying down in the stall region, the resting boxes, milk pails, calving pens, continuous claw baths, hand brushes, boots, rubber gloves and work clothes as well as a milking robot.

Disinfection of individual parts or of all these parts and components is preferred. For the disinfection of work clothes and similar, a washing machine can be operated with disinfectant solution.

The device according to the invention and the method according to the invention can be used in conventional milking technology and also in automatic and semi-automatic milking systems.

Preferably, the device is suitable for milking an animal and includes at least one milk line, at least one vacuum line, and at least one milking machine. Both the milking installation as a whole as well as the milking machine are subjected to disinfection at predetermined or regular or sensor-determined intervals using, for example, a combined cleaning and disinfection process, in order to clean the component from foreign substances and in order to prevent spreading of pathogens. Rinsing or partial disinfection of individual parts, for example, the milking machine, can be performed, for example, after each milking process, while the entire milking installation is cleaned and disinfected as a rule at certain time intervals.

The disinfectant can be sprayed into the ambient air. The number of germs can be reduced by spraying the disinfectant into the ambient air.

In a preferred further development, a control device is provided with which the disinfection process can be controlled.

With the control device, the intensity of the disinfection can be controlled at least as a function of one parameter, where usually the parameter is chosen from a group of parameters which include the time of action of the disinfectant, temperature of the disinfectant, concentration of the disinfectant and composition of the disinfectant.

In a further preferred development of the invention the (finished, prepared) disinfectant contains disinfectants other than chlorine dioxide. The amount of chlorine dioxide in the total disinfectant or the concentration of chlorine dioxide can be varied and adjusted to the specific situation in order to be able to react flexibly to the particular requirements.

Even when chlorine dioxide is used alone as disinfectant, an increased or higher concentration of the disinfecting agent in the disinfectant solution can be selected or predetermined, for example, at specific time intervals or after a predetermined or selectable number of milking processes. Even then the concentration of chlorine dioxide can be varied and adjusted to the specific situation in order to be able to react flexibly to the particular requirements.

Preferably the control device emits a disinfectant signal when a predetermined limiting value is reached, in which case, the predetermined value, for example, limiting value is reached, when the number of milkings and/or the number of teat cleanings were performed and/or a predetermined time has passed.

The control device can emit a disinfectant signal when an animal, in which the probability of disease exceeds a predetermined degree, was milked or handled. The probability can be determined with a sensor or can be determined from available data.

In an advantageous further development of the invention, a disinfecting process is performed when the control device emits a disinfection signal.

The base materials for the disinfecting agent are, for example, sodium chlorite, sodium chlorate, caroate, or an alkali chloride and an alkali- or alkaline-earth chloride, where caroate is a triple salt consisting of metal peroxomonosulfate, metal hydrogen sulfate and metal sulfate. At least one disinfectant base material preferably contains at least sodium chlorite or sodium chlorate.

The disinfectant base material is preferably a dry material which can also be in the form of a powder.

Also, at least one first disinfectant base material and at least one second disinfectant base material can be provided for the preparation of the disinfectant. Preferably, two, three, four, five or more disinfectant base materials can also be used for the preparation of the disinfectant. The disinfectant base materials react to form the disinfectant only when they are combined so that, for example, if they are stored separately, the storage stability is almost unlimited.

Preferably at least one disinfectant base material and especially preferably at least one first and a second disinfectant base material each are prepared, essentially as dry material.

Individual disinfectant base materials or all of them can be in the powder form.

The individual materials can be combined or dissolved in aqueous solution.

Before the preparation to make the disinfectant, the disinfectant base materials are stored at least partially separated from one another so that a first disinfectant base material is not in direct contact with a second disinfectant base material.

Preferably at least one disinfectant base material is in the tablet form. It is also possible that the first disinfectant base material and at least the second disinfectant base material be in the tablet form and preferably essentially uniformly distributed in it.

The first disinfectant base material and the second disinfectant base material can produce the disinfectant by chemical reaction.

However, it is also possible to have the individual disinfectant base materials be first in the powder form during manufacture, which are then pressed together into the tablet form. For example, the different disinfectant base materials can be kept in the tablet by a binder, which holds the different materials together and at the same time separates them reliably.

Similarly, the individual disinfectant base materials can also be surrounded by a separate protective shell, for example, a thin gelatin layer or similar. Such protective shells can provide reliable separation of the individual disinfectant base materials. By choosing the material of the protective shell suitably, it will dissolve quickly upon contact with water, so that the different components can react with each other right away in order to make the disinfectant available effectively within a short period of time.

It is also preferred that a first disinfectant base material and at least a second disinfectant base material be present together in one tablet, but then the distribution in this tablet is preferably essentially uniform.

The tablet form provides the advantage that, for a given amount of disinfectant, a corresponding amount of water or solvent and 1 tablet or a predetermined number of tablets is needed. The dosage per piece can then be handled easily so that the preparation of the desired amount of disinfectant is reliable and simple. On the other hand, dosage in the powder form has the advantage of greater flexibility, because a higher concentration of the disinfectant can be prepared by the addition of correspondingly larger amount of disinfectant base materials. Also the adjustment to the desired amount of disinfectant is simple in the case of the powder form.

In the method according to the invention, the performance of the process used follows from the previous description. Preferably at least one exposure time and/or one temperature and/or one concentration is controlled. After the ending of the disinfection process, preferably the excess disinfectant is discharged.

However, the invention is especially suitable not only for the use for disinfection, for example, of cleaning brushes used for the cleaning of udders. In automatic milking systems an animal can be milked fully automatically. For this purpose, the udder is cleaned before the milking process. A rotating brush is used, for example, for the cleaning system which is passed under the udder of the animal to be milked. After the cleaning of the udder is completed, the animal can be milked.

In a cleaning device known in the state of the art for the treatment of the udder, a cylindrical brush, held rotatably at the free end of a movable carrier, is brought from an initial position into a working position in which the brush is in working position with respect to the udder. When the carrier is moved out completely and the brush is in the end position, the brush is driven to rotate in order to clean the teats and the udder together. After the completion of the cleaning process, the carrier with the brush is moved back into the initial position.

In order to prevent transfer of bacteria and pathogens from one animal to the next, the brush is disinfected after each cleaning process. For this purpose, the brush can be moved under a hood where the brush is rinsed and disinfected. It is also possible that in the initial position that brush is located under a hood or similar which retains the water sprayed and similar during the disinfection and cleaning of the brush.

The brush can be rotatable around a hollow central axle. Then water, cleaning agent and disinfectant can be introduced to the brush through the central axle. For this purpose, to achieve better distribution of the agent, holes are distributed statistically preferably over a large part of the surface of the outer wall of the central rotary axle. Through these holes the disinfectant can leave the central axle and wet the individual bristles or brush hairs in order to clean and disinfect these. Here the disinfectant can be sprayed.

In an embodiment it is provided that rinsing agent and disinfectant can be sprayed on the cleaning brush from the protective device arranged above the brush as well as passing rinsing and disinfectant into the central axle of the brush which then exits through the holes and wets the brush. With the central introduction of the disinfectant an especially effective disinfection can be achieved since the individual bristles or brush hairs are wetted from the middle. This ensures reliable wetting of the entire surface of the bristles, especially since the brush can be put into rotation during the introduction of the disinfectant in order to compensate for the influence of gravity. Rotation can make sense even during the subsequent rinsing of the cleaning brush in order to remove the disinfectant reliably.

It is also possible to provide a number of spray nozzles or similar on the covering device in order to spray the cleaning brush in the initial position or in the disinfecting position with the disinfectant. For example, 3, 6, 8, 12, 16 or 24 nozzles can be provided in order to apply disinfectant uniformly from the outside onto the brush. During spraying the brush can rotate, preferably not so fast that the entire disinfectant is centrifuged off directly again as a result of the centrifugal force. For example, rates of rotation from 30 to 900 rpm and preferably in the range around 200 rpm are possible.

After the disinfection, rinsing with water followed by centrifuging can be applied in order to dry the brush. Higher rates of rotation are possible in this case. In an embodiment the rotation is 700 rpm. A possible cleaning of the udder is disclosed in German Patent Application DE 295 10 417 U1, to the content of which reference is made here explicitly.

After cleaning, the udder can be stimulated with a separate device in order to initiate milking. The invention can be used both for disinfection of the cleaning devices as well as for disinfection of a stimulation device or of the components that lead the milk away or of other milking components.

As a rule, the udder is post-treated after milking, by disinfecting and/or treating the udder. The device according to the invention or the method according to the invention can be provided and adapted both for the disinfection or such treatment devices. The disinfectant can also be used for post-dipping, that is, for disinfection of the teats after milking. When the laws allow, pre-dipping of the teats before milking in the disinfectant is also possible.

In a preferred embodiment, at least one sensor is provided in all the embodiments described above which measures the pathogen or germ load on or in the component to be disinfected and adjusts the duration of disinfection to the actual load. Similarly, the concentration or temperature of the disinfecting solution can be selected as a function of the measured result.

A rinsing process which follows the disinfection process in order to remove residues of the disinfectant can also be controlled with respect to time and amount. For example, after rinsing with pure water over a previously defined time period, the component to be disinfected can be released for the next animal. The ending of the subsequent rinsing process can also be controlled with the aid of a sensor. For this purpose, the concentration of the disinfectant itself or of a characteristic measure for it or of another additive of the disinfectant can be measured continuously or periodically. After the measured value is below a predetermined or selectable characteristic value, the rinsing process can be ended.

Preferably, the duration of the disinfection or the temperature or the disinfection or the concentration of the disinfectant is to be adapted to the health status of the animal (for example, determined through the number of cells during the last milking), which was previously in contact with the component to be disinfected.

It is also possible to perform a separate disinfection when a signal is given for this by the control. This signal can be given based on existing individual data of the animal. The decision about a separate disinfection can also be made as a function of any automatic detection of the health of the udder. For example, after a milking process, a subsequent disinfection of the milking machine can be initiated by a control when the number of cells (or a measure for the guide value for the milk or the temperature of the milk or the animal or similar) in the milk or in the pre-milk or post-milk exceeds a predetermined value, while if the limiting values are observed, for example, only rinsing or cleaning is performed.

A disinfection signal can also be triggered, for example, when an animal is sick or was sick recently without any concrete measured values being available during the actual milking process.

Data about the state of health can be placed in a memory of the control during the milking itself or also independently or these can be recorded. Generation or a disinfection signal can also occur, for example, when the number of cells is not determined during milking or directly afterwards. A disinfection signal can also be outputted based on other measured parameters. Thus, a disinfection signal can be provided as a function of the guide value, a measured milk, animal or udder temperature, a determination of the number of organisms carried out (online) or based on any other measured value.

For example, if the amount of milk measured or the duration of the milking of one quarter or of the entire animal is below a predetermined value (optionally depending on the individual animal) a preventive disinfection can also be performed, for example, of the milk-conducting parts, since a disease could be the reason for the above. As a result, infection of other animals is avoided.

A control device monitors the milking process. If it is found that the milking machine falls down during the milking process, this is recorded and preferably stored in memory. A teat cup which falls on the ground can have significantly higher germ load as a result. Therefore, in such cases the control device can issue a disinfection signal for the milking machine or for the particular teat cup or for the corresponding component, so that the corresponding component can be subjected to disinfection or possibly cleaning after the milking in order to keep the germ load low for the next animal. A teat rubber can be immersed into a disinfectant container for the purposes of disinfection, the container being filled with disinfectant solution or filled with it when needed.

In another embodiment, the device is provided in a milking station or represents such. When, for example, an animal to be milked defecates in the milking station and this is detected through suitable sensors, again a disinfection signal can be issued by the control device. Defecation can be detected through weight measurement, temperature determination of the milking station floor, conductivity measurement on the milking station floor or using other methods. If a disinfection signal is issued, the floor is disinfected and optionally cleaned before or at the same time.

The intensity of the disinfection can be varied in all cases and be determined as a function of the actual situation. If it is found that an animal is infected with an infectious disease, preferably intense disinfection is performed. This can be achieved by using increased time of exposure, temperature or concentration, adjusted composition or several of the above measures.

The status data necessary for this about the state of health of the animal can be detected with sensors and can be evaluated by the control device. For example, using temperature sensors, guide value sensors, or based on the total amount or quarter milk milked or based on the total milking duration or quarter milking duration, the health status can be estimated. If the probability of disease exceeds a predetermined measure, a disinfection signal is issued. The health status can also be known, for example, stored in a memory of the control device or of the device.

In the case of a cleaning brush, the intensity of disinfection of this can be chosen as a function of the result of the previous milking process or previous milking processes. The determination of the intensity (time, temperature, concentration, material selection) of the disinfection can also be performed as a function of the various sensor data or other parameters, in order to avoid transfer of pathogens or diseases reliably.

In the disinfection process, a second or even a third disinfectant can be used as a support in order to accelerate the disinfection process or to improve it. For example, the use of hydrogen peroxide or ozone is possible. Similarly, UV radiation can be used as support. The addition of a known cleaning agent is also possible.

Separate protection is provided for a device for preparing a disinfectant for milking components. This device has at least one container for storing at least one disinfectant base material and at least one preparation device, with which from the at least one disinfectant base material, a disinfectant can be produced by chemical reaction, the disinfectant preferably containing chlorine dioxide. At least one line or discharge device is provided which is suitable to bring the disinfectant preferably in contact with at least one milking component essentially directly after preparation, in order to disinfect the device. Embodiments of preferred further developments of this variant correspond to the further developments described before in an adapted form.

Furthermore, the applicant reserves the right to claim a milking device which includes a device for disinfection of at least one milking component. Here at least one container is provided for storing at least one disinfectant base material. At least one preparation device is provided with which a disinfectant can be prepared by chemical reaction from at least one disinfectant base material. Furthermore, at least one discharge or line device is provided with which the disinfectant can be brought into contact with at least one milking component, preferably essentially directly after preparation, in order to disinfect the milking component. Preferably at least one disinfectant contains chlorine dioxide. A protection for system or installations which include a milking device and/or a milking plant and/or a milking station and/or at least one milking component is also claimed. The milking component can be one mentioned in this application.

Other advantages and characteristics of the present invention are now explained with reference to the figures.

These show the following:

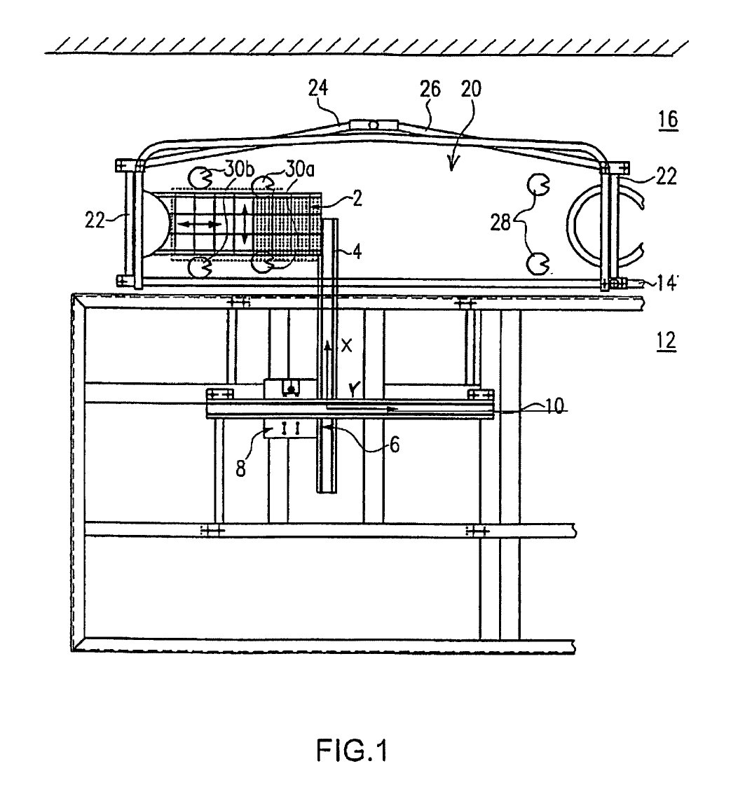

FIG. 1 is an udder-cleaning device as a first practical example, and

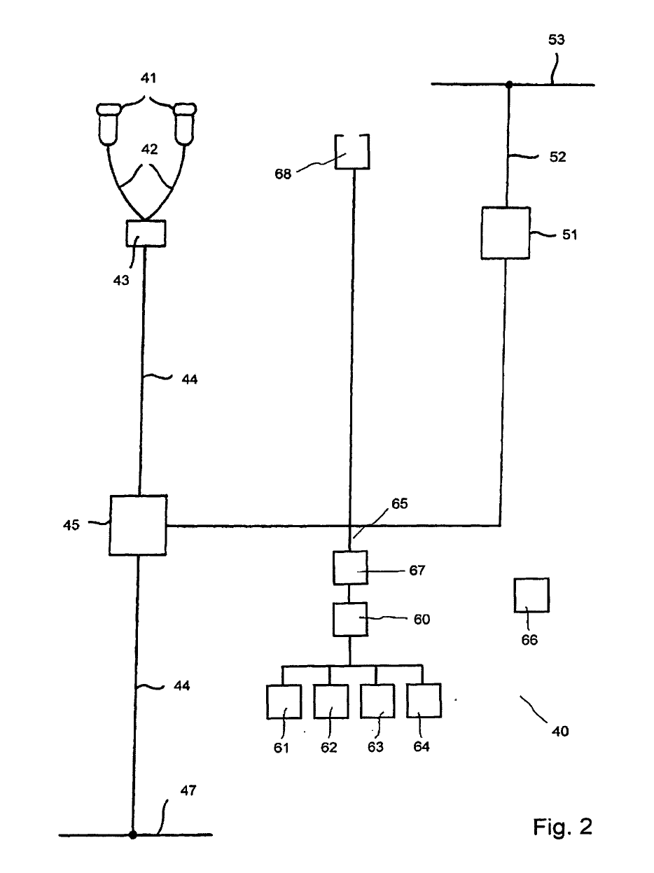

FIG. 2 is a milking device as a second practical example.

The present invention will be explained below with the aid of a first practical example of a cleaning device for cleaning the udder in combination with FIG. 1. FIG. 1 is a schematic top view of a milking station.

The practical example shown in FIG. 1 is a cleaning station of a milking station as it is known, for example, from DE-U-295 10 417. This milking station has several animals to be milked in the direction of movement, in this case cows, in boxes arranged one behind the other. The cleaning station is in the first box. In the following boxes in each case a milking machine is attached onto a cow to be milked.

The practical example shows a cleaning station for cleaning the udder of an animal where the cleaning station can be disinfected. Similarly, according to the invention, a different treatment device for disinfection can be provided. Especially, simulation, disinfection and post-treatment devices for treatment and/or disinfection can be realized according to the invention.

At this point let us emphasize again that preferably the entire milking installation is disinfected by the method according to the invention. Known methods can be used for this, as they are customary in the state of the art. For example, the cleaning can be performed using a batch method. Similarly, various cleaning and disinfection processes can occur one after the other, where the disinfectant used in the individual processes is collected and reused. For this purpose, the disinfectant can be reinforced. Similarly, the temperature or the residence time of the disinfection can be chosen as it is known in the state of the art.

Therefore, fundamentally, during disinfection the same steps are possible as they are described in German Patent Application DE 195 41 646 A1. Even more preferably, the process steps are carried out in another embodiment similarly to the steps disclosed in WO 00/067561 A1 where in both cases the disinfectant preferably contains chlorine dioxide.

In the practical example shown, the cleaning station is a rotatably-driven brush 2 at the free end of a carrier 4 of the cleaning device, attached rotatably. Carrier 4 is supported in a first guide 6 so it can be shifted longitudinally. This first guide 6 is moved again in a second guide 8, transverse to the guide direction of the first guide 6, this second guide 8 running along the fixed tracks 10.

As a result of this design, brush 2 can be moved in an orthogonal coordinate system where the first guide 6 permits movement in the X-direction and the second guide 8 permits movement in the Y-direction, where the plane determined by the X-direction and Y-direction lies essentially parallel to the ground. Moreover, by swiveling carrier 4 or as a result of a linear shift from the plane drawn, brush 2 can also be moved in the Z-direction.

Guides 6, 8 as well as tracks 10 are in an engineering space 12, which is separated from a passage 16 for the cows by a screen 14. A box 20 that holds the cows in the cleaning station has further screens 22 at its front and back sides, and on its longitudinal side, that faces the engineering space 12, it has two automatically controlled inlet and outlet doors 24, 26 which are supported so that they can swivel.

In box 20, six footprints of a cow to be milked are shown schematically. These are the front claws 28 of a large and a small animal, as well as the back claws 30a of a small animal and 30b of a large animal.

An animal to be milked located in the passage 16 enters through the open inlet door 24 first of all into box 20. The inlet door 24 closes automatically. Independently of the size of the animal then the brush which is at first in the starting position within the engineering space 12 moves through the barrier grid 12 [sic, should be 14] into box 20 in the X-direction until it reached its end position with respect to the X-coordinate.

As soon as the cleaning position for cleaning the udder of the cow regarding the X-coordinate is reached, a carrier 4 moves together with brush 2 along the longitudinal extension of tracks 10 in the Y-direction until the cleaning position with respect to the Y-direction coordinate and thus the end position is reached. This can be variable and determined, for example, by a device which is known from DE-A-199 01 241 for rough positioning of the milking machine below the udder of a cow.

The first and second guides 6, 8 shown in the practical example according to FIG. 1 are the conventional groove guides. The drive is always provided through a drive motor which is not shown here, the drive wheel of which acts on the carrier 2 [sic, number 2 was used to designate “brush before”] and on the other hand on tracks 10. The torque of the particular motors is monitored. The corresponding signal is sent to an evaluation device which is not shown here.

If the brush 2 bumps during the process from the initial position into the end position, for example, into the leg of a cow standing in box 20, then the torque of the drive motor immediately increases greatly, which is recognized by the evaluation device. Then this acts on the particular drive motor in such a way that the motor stops and optionally it is driven in the opposite direction.

After completion of the cleaning of the udder, the brush returns to the initial position and is disinfected with a disinfectant before the udder of the next animal is cleaned. The disinfectant contains chlorine dioxide which can be stored only to a limited extent and must not be transported from one place to another. Therefore, the disinfectant is prepared on location as needed, by dissolving the disinfectant base materials simultaneously in water. For this purpose, for example, alkali and/or alkaline-earth chlorite and a mixture of caroate and alkali chloride are suitable. It is also possible to dissolve the alkali- and/or alkaline-earth chlorite and alkaline metal peroxydisulfate in water. The preparation can also proceed by dissolving alkali- or alkaline-earth chlorite and iron or aluminum salt in water or also alkaline-earth chlorite. Regarding the preparation, reference is made, for example, to DE 195 18 464 A1 and there to Column 1, Line 1 to Column 6, Line 47, and especially to Column 1, line 54 to Column 5, Line 14. The disinfectant is introduced to the central axle of the brush and is distributed over the entire brush through small holes so that reliable disinfection follows. Then it is rinsed with clean water in order to rinse out the disinfectant and then the brush is rotated to dry.

If the udder-cleaning brush after the cleaning the udder is highly contaminated, cleaning of the brush is appropriate. The cleaning can be done by the use of cleaning agents, for example, those which dissolve the adhering dirt or at least facilitate this. In order to support the cleaning action, for example, mechanical action on the brush is possible. At the same time or subsequently, the disinfectant can be added which will result in a significant reduction of the number of germs.

FIG. 2 shows a milking device 40 according to the invention. The milking device has teat cups or milking cups 41 which are connected to a connecting piece 43 through a short milk tube 42. The exit of connecting piece 43 is connected to a milk line 47 through a milk tube 44.

For disinfection, a processing device in the form of a reactor 60 is provided. Reactor 60 is connected to at least one container 61 which contains a disinfectant base material. In the example shown here, four (different) disinfectant base materials can be used from containers 61, 62, 63, and 64 in order to prepare the disinfectant used for disinfection from these by chemical reaction. The control of the installation and of the essential components is done through a control device 66 which is designed here as a computer.

The water for the aqueous solution of the disinfectant is taken from the water line 53 through line 52. A tempering station 51 serves to heat the water.

An intermediate storage 67 is provided to store the completed disinfectant (in the meantime). Therefore the production of the chlorine dioxide solution in the example shown can be done continuously or over a long period at a relatively low level in order to be able to cover the peak demand simply. If needed, the production can be increased.

From the intermediate storage 67, the disinfectant goes through a line 65 to the milk tube 44. A locking and guide unit 45 is provided at the inlet. It is possible here to guide the disinfectant solution to the milk collecting piece 43 and to the teat cups or only (or also simultaneously) through the milk tube 44 to the milk line 47.

Especially, the teat cups can be subjected to rinsing the entire head by immersing them, for example, into the disinfectant container 68 or connecting it to it.

The sequence in FIG. 2 is only an example. Any other line connections and disinfectant paths can be used for disinfection (and cleaning) as they are known in the state of the art.

### REFERENCE LIST

2 Brush
4 Carrier
6 First guide
8 Second guide
10 Tracks
12 Engineering space
14 Barrier grid
16 Passage
20 Box
22 Grid
24 Inlet door
26 Exit door
28 Front pair of claws
30a Back pair of claws, small animal
30b Back pair of claws, large animal
40 Milking device
41 Teat cup
42 Short milk tube
43 Milk collecting piece
44 Milk tube
45 Locking and guide unit
47 Milk line
51 Tempering station
52 Line
53 Water line
60 Reactor
61 Container
62 Container
63 Container
64 Container
65 Line system
66 Control system
67 Intermediate storage
68 Disinfectant container

1. A device for disinfection of a milking component with at least one container for storing at least one disinfectant base material;
at least one processing device with which, from at least one disinfectant base material, a disinfectant which contains chlorine dioxide can be prepared by chemical reaction;
at least one guiding element with which the disinfectant can be brought into contact with at least one milking component essentially directly after preparation, in order to disinfect the milking component.

2. The device according to claim 1, wherein the milking component to be disinfected is a component which comes into direct contact with at least one part of the udder of the animal to be milked, during milking.

3. The device according to claim 1, wherein the milking component to be disinfected is taken from a group of components consisting of:
teat cups, udder- and teat-cleaning equipment, pre- and post-dipping devices and similar others.

4. The device according to claim 1, wherein a disinfectant container is provided into which at least one milking component can be immersed, in order to make disinfection possible, essentially on all sides.

5. The device according to claim 1, wherein the milking component to be disinfected is a component which comes into contact with the milk of a milked animal.

6. The device according to claim 1, wherein the milking component is taken from a group of components consisting of:
teat rubber, teat cup, milk collecting components, milk lines, milk tubes, milk flowmeter, sensors for the determination of milk quality and flock and blood detectors, receiving containers, milk pumps, milk tanks and similar others.

7. The device according to claim 1, wherein the disinfectant can be circulated in a closed circuit.

8. The device according to claim 1, wherein the milking component to be disinfected is a component which comes into contact with an animal, whereby the component is taken from a group of components, consisting of:
animal watering troughs, as well as water lines to the animal troughs, feed troughs and calf drinking troughs and calf nipples, resting quarters, milking stations and milking robots.

9. The device according to claim 1, wherein the device is suitable for the milking of an animal and it includes at least one milk line, at least one vacuum line and at least one milking machine.

10. The device according to claim 1, wherein the disinfectant can be sprayed into the ambient air.

11. The device according to claim 1, wherein a control device is provided with which a disinfecting process can be controlled.

12. The device according to claim 1, wherein using the control device the intensity of disinfection can be controlled via at least one parameter.

13. The device according to claim 1, wherein the parameter is chosen from a group of parameters consisting of:
an action time of the disinfectant and a temperature of the disinfectant and a concentration of the disinfectant and a composition of the disinfectant.

14. The device according to claim 1, wherein the control device emits a disinfection signal when a predetermined limiting value is reached.

15. The device according to claim 1, wherein the predetermined limiting value is selected from the group consisting of:
the number of milkings; the number of teat cleanings; a predetermined time has elapsed; and combinations thereof.

16. The device according to claim 14, wherein the control device emits a disinfection signal when an animal for which the possibility of disease exceeds a predetermined degree was milked or treated.

17. The device according to at least one of the previous claims 14, wherein a disinfection process is performed when the control device emits a disinfection signal.

18. The device according to claim 1, wherein at least one disinfectant base material contains includes sodium chlorite or sodium chlorate.

19. The device according to claim 1, wherein at least one disinfectant base material is an essentially dry solid.

20. The device according to claim 1, wherein at least one disinfectant base material is in the powder form.

21. The device according to claim 1, wherein a first disinfectant base material and at least one second disinfectant base material is provided for the preparation of the disinfectant.

22. The device according to claim 1, and further comprising a second disinfectant base material stored separately from the first disinfectant base material prior to being mixed in the processing device.

23. The device according to claim 1, wherein the first disinfectant base material is in the tablet form.

24. The device according to claim 22, wherein the first disinfectant base material and the second disinfectant base material produce the disinfectant by chemical reaction.

25. A method for the disinfection of a milking component, comprising the step of:
producing a disinfectant by chemical reaction with a disinfectant base material, the disinfectant containing chlorine dioxide, and disinfecting the milking component with the disinfectant.

26. The method according to claim 25, wherein an exposure time and/or a temperature and/or a concentration is controlled.

27. The method according to claim 25, and further comprising the step of:
discharging the disinfectant after the milking component is disinfected.

28. The device according to claim 1, wherein at least one disinfectant base material includes sodium chlorate.
